(19) United States
(12) Patent Application Publication
(10) Pub. No.: US 2007/0107020 A1
(43) Pub. Date: May 10, 2007

(54) System and method for providing reliable wireless home media distribution

(75) Inventor: Clifford Tavares, San Carlos, CA (US)

Correspondence Address: SQUIRE, SANDERS & DEMPSEY L.L.P., 1 MARITIME PLAZA, SUITE 300, SAN FRANCISCO, CA, 94111, US

(73) Assignee: Hitachi, Ltd.

(21) Appl. No.: 11/271,011

(22) Filed: Nov. 10, 2005

(51) Int. Cl. H04N 7/18

(52) U.S. Cl. 725/81; 725/80; 725/78

(57) ABSTRACT

A system provides reliable wireless home media distribution. The system comprises a wireless source device; a wireless sink device; and a wireless controller including a sensing module for sensing potentially interfering signals in the path of the wireless source device and the wireless sink device; an admission module for obtaining communication need information for effective communication between the wireless source device and the wireless sink device; and an allocation module for selecting an RF channel based on the potentially interfering signals and the communication need information for the wireless source device and the wireless sink device to intercommunicate.

### TECHNICAL FIELD

This invention relates generally to wireless devices, and more particularly provides a system and method for providing reliable wireless home media distribution.

### BACKGROUND

Current wireless networks have many limitations. For example, current wireless networks (e.g., 802.11 a/b/g) are designed for data traffic and are poorly suited for media delivery, e.g., audio and video. Although new technologies allow for wireless voice applications (e.g., wireless IP phones), current wireless networks are ineffective for high quality media transmission, e.g., from DVD players or projectors. Further, current wireless technologies are designed to operate in busy environments, e.g., public places, and assume mobility of clients and dynamic changes. To achieve reliable operation in busy environments, conventional wireless devices introduce significant information overhead to manage error correction, concealment and synchronization with peers. Information overhead may include, for example, MAC headers, fragmentation, IP headers, retransmit requests, etc. In fact, overhead often accounts for over 30% of transmitted data. The use of several wireless devices in busy environments may exhaust spectrum resources, possibly resulting in denial of service to new devices entering the environment. Further, new devices may cause interference, thereby causing disruption of service to existing devices.

Unlike public places, a home environment is relatively fixed in terms of the number of media devices in use at any point in time. Accordingly, devices configured to communicate in the busy environment overuse spectrum resources in the home environment. In other words, the additional overhead for reliable operation in busy environments results in significant cost increase and inefficient spectrum use both at the client and at the access point. Further, because mobile devices are not stationary, effective power management schemes cannot be applied, resulting in high battery consumption.

Systems and methods are needed for enabling a wireless network capable of providing high quality media transmission, improved spectrum usage, and reduced overhead, especially in the home environment.

### SUMMARY

One embodiment herein allows for reliable wireless media device communication in a home environment with reduced interference and improved end-to-end quality of service. The home environment architecture may include “thin radio clients” with basic communication and management support functions and a “thick centralized server” that programs the thin radio clients for optimal operation.

The architecture may effect reliable home media distribution by managing spectrum resources, e.g., by combining the following three schemes within a media device connection topology: (1) interference mitigation (e.g., recognizing and accounting for the interference caused by disruptive devices, such as microwaves, furnaces, etc., and/or wireless communication devices, such as cordless telephones, wireless networks, thin radio clients, thick centralized servers, and/or other RF devices), (2) traffic prioritization (e.g., prioritizing multiple wireless communication devices in operation), and (3) establishment of air resource management policies (e.g., for managing radio frequency spectrum usage).

In one embodiment, the architecture assumes that wireless devices like DVD players, receivers, televisions, speakers, etc. will be relatively stationary during power-on and playback sessions. Exploiting this assumption, the architecture can learn the behavior of the air-space links between communicating wireless devices, e.g., between peers.

In one embodiment, the present invention provides a system, comprising a wireless source device; a wireless sink device; and a wireless controller including a sensing module for sensing potentially interfering signals in the path of the wireless source device and the wireless sink device; an admission module for obtaining communication need information for effective communication between the wireless source device and the wireless sink device; and an allocation module for selecting an RF channel based on the potentially interfering signals and the communication needs for the wireless source device and the wireless sink device to intercommunicate.

The source device may include a DVD player, and the sink device may include a television. The source device may include a music player, and the sink device may include speakers. The source device may include a computer, and the sink device may include a television. The sensing module may include a single sensor for sensing the interfering signals for the entire operating environment or may include distributed modules for sensing the interfering signals for the entire operating environment. The sensing module may sense interfering signals periodically, and may sense ambient interfering signals. The communication needs may include Tspec and Rspec for the source device and the sink device. The allocation module may select the RF channel further based on available channels, and further based on noted problems.

In another embodiment, the present invention provides a method, comprising sensing potentially interfering signals in the path of a wireless source device and a wireless sink device; obtaining communication need information for effective communication between the wireless source device and the wireless sink device; and selecting an RF channel based on the potentially interfering signals and the communication needs for the wireless source device and the wireless sink device to intercommunicate.

The source device may include a DVD player and the sink device may include a television. The source device may include a music player and the sink device may include speakers. The source device may include a computer and the sink device may include a television. The sensing may include using a single sensor to sense the interfering signals for the entire operating environment or using distributed modules to sense the interfering signals for the entire operating environment. The sensing may sense interfering signals periodically and may sense ambient interfering signals. The communication needs may include Tspec and Rspec for the source device and the sink device. The selecting may select the RF channel further based on available channels and further based on noted problems.

### BRIEF DESCRIPTION OF THE DRAWINGS

FIG. 1 shows a block diagram of a network architecture in accordance with an embodiment of the present invention;

FIG. 2 shows a block diagram illustrating details of the wireless home media controller;

FIG. 3 shows the state behavior machine for the wireless home media controller;

FIG. 4 is an example flow diagram illustrating the use of the wireless home media controller;

FIG. 5 is block diagram illustrating example details of the wireless abstraction layer;

FIG. 6 is a block diagram illustrating example details of the wireless home media controller;

FIG. 7 is a block diagram illustrating example details of the policy database; and

FIG. 8 is a block diagram illustrating details of an example computer system, of which each wireless client devices and home media controller may be an instance.

### DETAILED DESCRIPTION

The following description is provided to enable one person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

One embodiment herein allows for reliable wireless media device communication in a home environment with reduced interference and improved end-to-end quality of service. The home environment architecture may include “thin radio clients” with basic communication and management support functions and a “thick centralized server” that programs the thin radio clients for optimal operation.

The architecture may effect reliable home media distribution by managing spectrum resources, e.g., by combining the following three schemes within a media device connection topology: (1) interference mitigation (e.g., recognizing and accounting for the interference caused by disruptive devices, such as microwaves, furnaces, etc., and/or wireless communication devices, such as cordless telephones, wireless networks, thin radio clients, thick centralized servers, and/or other RF devices), (2) traffic prioritization (e.g., prioritizing multiple wireless communication devices in operation), and (3) establishment of air resource management policies (e.g., for managing radio frequency spectrum usage).

In one embodiment, the architecture assumes that wireless devices like DVD players, receivers, televisions, speakers, etc. will be relatively stationary during power-on and playback sessions. Exploiting this assumption, the architecture can learn the behavior of the air-space links between communicating wireless devices, e.g., between peers.

The term “media” refers to data, audio and/or video content. The term “distribution” refers to transmission of content, whether via streaming, file transfer, real time transfer, bursty and sustained transfer, hi or low throughput, or high or low latency. The term “source device” refers to a device that sources media content, e.g., a DVD player. The term “sink device” refers to a device that receives the media content, e.g., a TV or computer monitor, from a source device.

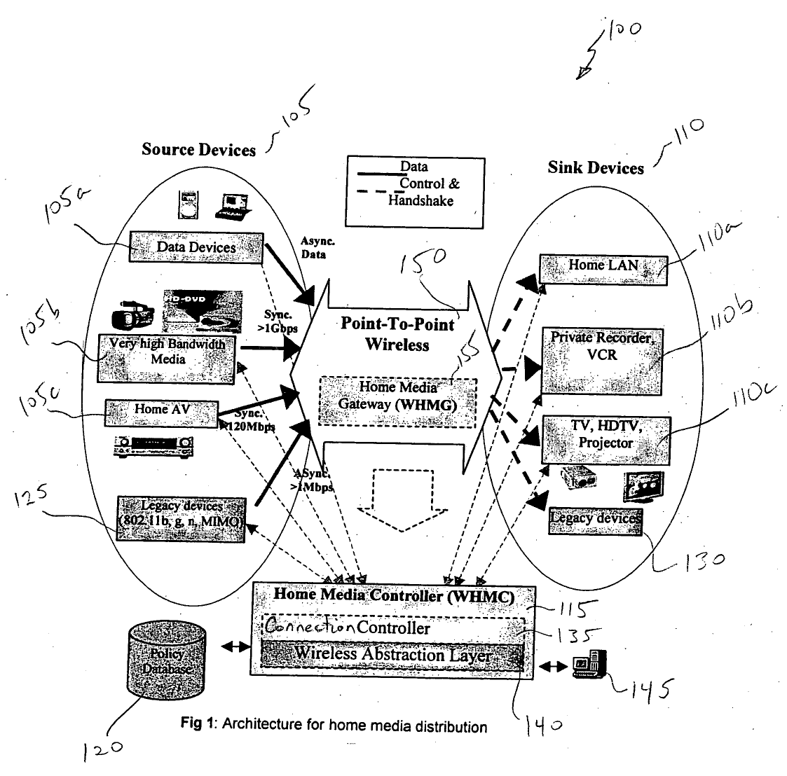

FIG. 1 shows a block diagram of a network architecture 100 in accordance with an embodiment of the present invention. Network architecture 100 includes source devices 105 coupled via a wireless point-to-point network 150 to sink devices 110. A wireless home media controller 115 (e.g., a “thick centralized server”) is communicatively coupled to each of the source devices 105 and sink devices 110 and to a policy database 120. Point-to-point network 150 may include a wireless home media gateway (WHMG) 155 operated by wireless home media controller 115. The wireless point-to-point network 150 may use conventional wireless addressing schemes, communication protocols, data formats, etc. Wireless home media controller 115 may operate on a computer system, e.g., computer system 145.

Source devices 110 may include data-centric devices 105a such as typical laptop computers and personal data assistants, very high bandwidth media-centric devices 105b such as DVD players and camcorders, home audio visual equipment 105c, and legacy source devices 125 that use for example 812.11b, g, n, MIMO, etc. Sink devices 115 may include home local area networks 110a, private recorders or VCRs 105b, televisions, high definition televisions or projectors 110c, and legacy sink devices 130. It will be appreciated that some devices may operate both as sources and sinks, e.g., a VCR. All source devices 105a, 105b, 105cand sink devices 110a, 110b, 110c are referred to herein as “wireless client devices” or in some embodiments as “thin radio clients.”

Each wireless client device communicates with the wireless home media controller 115 over a predetermined dedicated control channel during bootstrap and runtime reporting. It will be appreciated that each wireless client device and the wireless home media controller 115 may have more than one predetermined dedicated control channel for intercommunication, and may cycle through the available channels to find one that performs effectively. The wireless home media controller 115 may determine a single channel for all to wireless communication devices in the network 100 to use, or may determine on a device-by-device basis an optimal channel for each wireless client device to use when communicating with the wireless home media controller 115.

During an initialization phase, e.g., at set up, upon system reset, or upon detection of an architecture 100 change (e.g., addition or movement of a wireless client device, movement of the wireless home media controller 115, addition or movement of a legacy device, etc.), the wireless home media controller 115 senses ambient air spectrum use for the environment supported by the architecture 100, e.g., in the home. By determining ambient air spectrum use, the wireless home media controller 115 can determine which radio frequencies may be unavailable due to disruptive devices, which radio frequencies are used by unmodifiable legacy devices 125 and 130, etc. In this context, the term “ambient” refers to the spectrum use when no wireless client devices are operating.

During an admission phase, the wireless home media controller 115 obtains information about each of the wireless client devices (e.g., each wireless client device's requirements, available RF spectrum channels, etc.), registers each of the wireless client devices, and presents the available wireless client devices via a user interface to a user. Each wireless client device may be dynamically programmable using wireless bootstrap program/settings downloaded from the wireless home media controller 115.

After a user selects a source/sink pair for media playback, architecture 100 begins an allocation phase. Using the information obtained during ambient air spectrum use sensing, the spectrum use of other wireless client devices currently operating, available RF channels, and the needs of the source/sink pair, the wireless home media controller 115 determines an RF channel over which the source/sink pair can communicate.

It will be appreciated that the wireless home media controller 115 may sense air resource spectrum use regularly (e.g., periodically, at predetermined times, upon detection of certain events, intermittently, continuously, etc.) to improve RF channel selection for specific source/sink pairs. For example, during the initial ambient air spectrum use sensing, a microwave may not have been operating. At that sense time, the wireless home media controller 115 would not have noted the RF interference of the microwave. However, by additional sensing, the wireless home media controller 115 may learn the existence and/or location of certain interfering devices and may select RF channels accordingly. Further, the wireless home media controller 115 may monitor prior source/sink pair failures, and may learn which channels give which source/sink pairs more problems. Again, the wireless home media controller 115 may select RF channels accordingly. It will be appreciated that many other factors may play into RF channel selection.

During the allocation phase, the wireless home media controller 115 transmits RF channel information and possibly other configuration information such as communication protocol to the source/sink pair. Using the configuration information, the source/sink pair intercommunicate to confirm that the RF channel selection and other configurations satisfy their needs, and inform the wireless home media controller 115. If the configuration does not satisfy their needs, the wireless home media controller 115 can re-select source/sink configuration. The allocation of configuration parameters can remain with the source/sink pair until instructed otherwise. That way, the system can avoid revisiting allocation for this source/sink pair. Alternatively, the allocation of configuration parameters can remain only until the system is turned off, until playback is stopped, until a new source/sink selection is made, for a given time period, until a predetermined event, etc. That way, the system can reuse the same RF channel for another source/sink pair when needed. Of course, other alternatives exist.

During the operation phase, the source and sink communicate therebetween over the configured RF channel. The wireless client devices communicate at maximum speed allowed by the channel using minimum overhead and schemes like the Block ACK scheme provided by 802.11e. Any communication protocol selected for such a ‘direct-link’ between wireless client devices may be implemented. If a problem arises, the source and/or sink informs the wireless home media controller 115. That way, the wireless home media controller 115 can address the issue immediately, possibly selecting another configuration. As stated above, the wireless home media controller 115 can retain information regarding problem events to assist with future configuration selection.

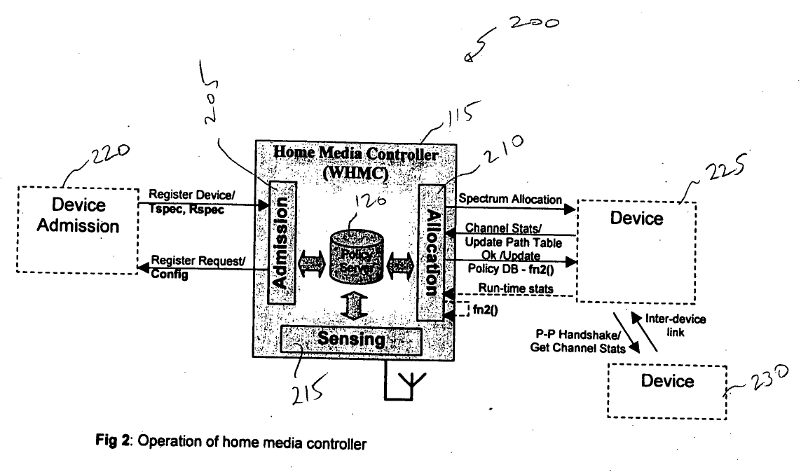

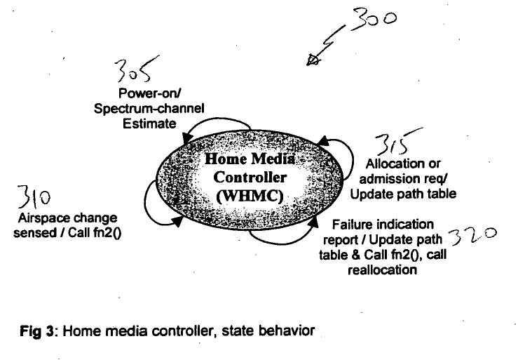

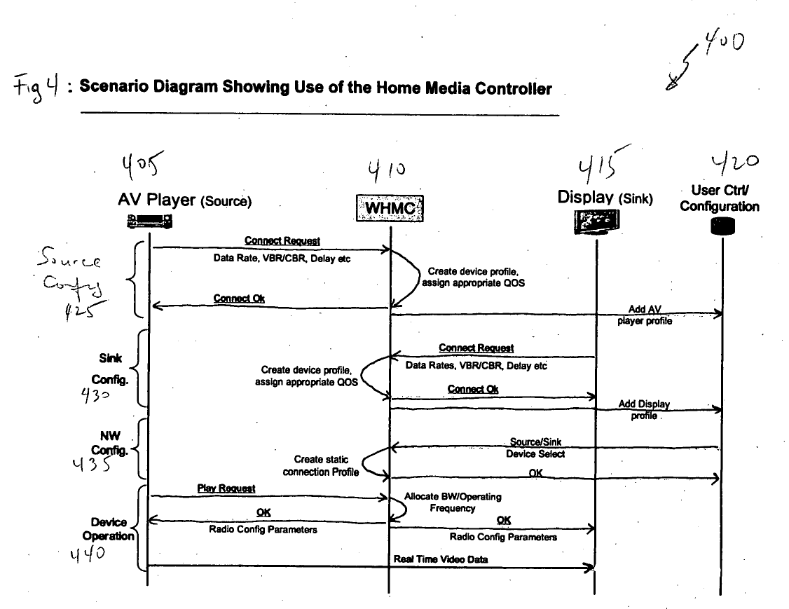

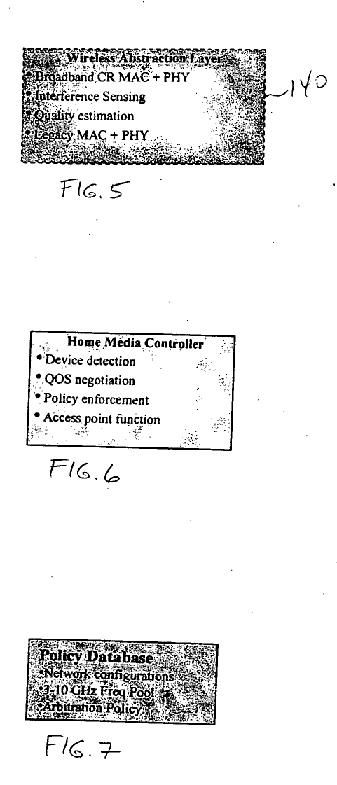

The wireless home media controller 115 includes a connection controller 135 and a wireless abstraction layer 140. The connection controller 135 is made up of an admission module that manages the admission phase described above, and an allocation module that manages the allocation phase described above. These modules are described in greater detail with reference to FIG. 2. The wireless abstraction layer 140 includes a sensing module that manages the sensing phase as described above. The wireless abstraction layer 140 is described in greater detail with FIG. 5.

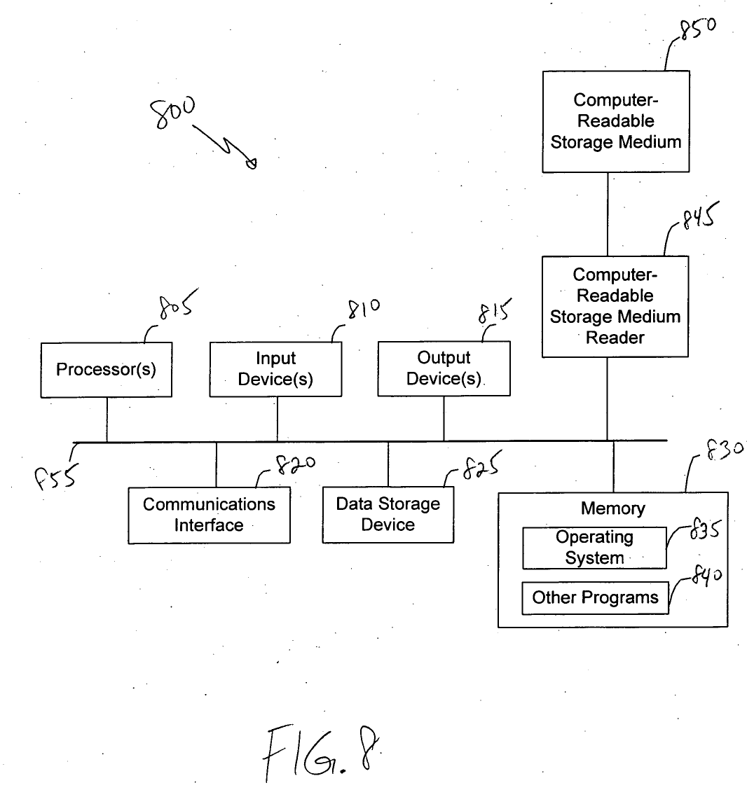

The policy database 120 provides an arbitration function, handling priority issues. The policy database 120 is described in greater detail with reference to FIG. 7.

It will be appreciated that, in some embodiments, the wireless home media controller 115 may communicate with and/or handle admission of only one of a source/sink pair. For example, by admitting the source device, all information needed by the sink device may be indirectly obtained. Further, in some embodiments, the wireless home media controller 115 may provide configuration parameters the source device, which can in turn provide configuration parameters to the sink device at runtime. In other embodiments, each source and sink device needs to be admitted. For example, in one embodiment, one source device may be selectably paired with various different sink devices, where each sink device has a different need. In such case, knowing the capabilities of the source device may be insufficient to determine the capabilities of the selected sink device. Again, other alternatives exist.

FIG. 2 shows a block diagram illustrating details of the wireless home media controller 115. The wireless home media controller 115 includes an admission module 205 that manages the admission phase described above, an allocation module 210 that manages the allocation phase described above, and a sensing module 215 that manages the sensing phase described above. Each of modules 205, 210 and 215 is communicatively coupled to the policy server 120.

The sensing module 215 senses ambient air resource spectrum usage in the environment. For example, the sensing module 215 may sense legacy devices, disruptive devices, etc. Further, the sensing module 215 may sense air resource spectrum use at various times, possibly sensing air spectrum use by other connected wireless client devices. The sensing module 215 is capable of sensing air resource spectrum use including interference from non-standard PHY/MAC radios like radars and from home utilities like microwave ovens.

The wireless home media controller 115 may perform the sensing function for the entire environment. Alternatively or additionally, the sensing module 215 may be distributed. For example, each wireless client device may include a client sensing module (not shown) which communicates with the sensing module 215 of the wireless home media controller 115. An example distributed architecture is described in U.S. Pat. Ser. No. 11/196,548, entitled “SYSTEM AND METHOD FOR PROVIDING EFFICIENT SPECTRUM USAGE OF WIRELESS DEVICES IN UNLICENSED BANDS,” filed on Aug. 2, 2005, by inventor Shiuh Yuan CHEN, which is hereby incorporated by reference.

A device 225 requesting admission to the network 100 sends a device admission request 220 to the admission module 205 of the wireless home media controller 115. The device admission request 220 includes operational specifications, e.g., Tspec and Rspec. Tspec (traffic specification) are Rspec (Service Request Specification) are known specifications for both wired and wireless networks (see RFC 2216). Generally, Tspec is a description of the traffic pattern for which service is being requested. Once a service request is accepted, the wireless home media controller 115 can agree to provide a specific quality of service as long as the data traffic of a flow continues to be accurately described by the TSpec. The actual provision for quality of service is made available by proxy in the form of the configuration program. Rspec is a specification of the quality of service a flow wishes to request from a network element. The contents of a service request might contain information about bandwidth allocated to the flow, maximum delays, or packet loss rates.

The admission module 205 checks Tspec and Rspec against the available channels and bandwidth. Based on Tspec and Rspec, the admission module 205 of the wireless home media controller 115 generates a configuration (bootstrap) for the wireless client device 225. This configuration may be based on initial power-on estimates received from the sensing module 215 and may include reporting protocol, periodicity, handshake method, operation frequency/s, power, and error correction scheme.

Based on the configuration developed by the admission module 205, the allocation module 210 of the wireless home media controller 115 assigns proper allocation parameters to the wireless client device 225. The allocation module 210 accesses a path table (example shown below) to identify a suitable air resource and allocate the suitable air resource to a wireless client device 225. The wireless client device 225 reports back with channel statistics (e.g., signal, strength, delay, etc.) for that resource. The allocation module 210 invokes the function fn2( ) to analyze the statistics. The intelligent update function fn2( ) is a learning algorithm that records and maintains a history of interferences, including periodic interference from Blue-tooth like frequency hopping devices. Fn2( ) updates the links in the path table based on assessment of air-space resource usage. Fn2( ) may also update the path table based on prediction based on past observations. If the statistics indicate a reliable channel, fn2( ) returns an ok, else, it updates the path table with new information. The allocation module 215 repeats its processes until the allocation module 215 successfully allocates an air-resource.

Shown below is an example path table. A path table maintains information about links between wireless client devices. The table is an example of a table generated as a result of three wireless client devices in a home environment.

| | | Available | | |
|---|---|---|---|---|
| | | channels In path | Channel | |
| Path/Link | Activity | (in priority) | stats | Link Policy |
| D1-D2 | Active | frq1, frq2 . . . | Stat1 | {Hi/Lo} |
| D2-D3 | Inactive | | Stat2 | |
| D2-D3 | Active | Frq4, frq5 . . . | Stat3 | |

** Co-channel interference parameter
Shown above: stat1 = {CCI**, SNR, Tx-Rx power, noise floor, hi, etc.}

The link between the wireless client devices 225 and 230 may use omni directional or MIMO-based beam-forming antennas. This link is shown in FIG. 2 as “Inter-device link.”

FIG. 3 shows the state behavior machine 300 for the wireless home media controller 115. The wireless client device 225 starts by sending a beacon in a fashion similar to the bootp (bootstrap protocol) in wired networks. A beacon serves to identify a new device and specify the quality of service requirements. For convenience, such a bootstrap protocol is referred to herein as “wbootp” (or “wireless bootstrap protocol”) . Similar to wired networks, wbootp allows for startup of a wireless client device which has no predefined behavior (no boot program).

The state behavior machine 300 illustrates that at power on (state 305), a spectrum channel estimate is performed. Upon detecting an air-space change (state 310), function fn2( ) is called. Upon receiving an allocation or admission request (state 315), the path table is updated. Upon a failure indication report (state 320), the path table is updated, function fn2( ) is called, and reallocation is performed.

FIG. 4 is an example flow diagram 400 illustrating the use of the wireless home media controller 115. Flow diagram 400 identifies four possible controlling components, namely, a source 405 (e.g., AV player), the wireless home media controller 410, a sink 415 (e.g., display), and user control/configuration 420. Flow diagram 400 includes four stages, namely, a source configuration stage 425, a sink configuration stage 430, a network (source/sink) configuration stage 435, and device operation stage 440.

Flow diagram 400 begins with the source configuration stage 425. Source configuration stage 425 begins with the source 405 sending a connection request to the wireless home media controller 410. The connection request may includes data rates, VBR/CBR, delay, etc. The wireless home media controller 410 creates a device profile and assigns appropriate quality of service. The wireless home media controller 410 then informs the source 405 that the connection is okay, and adds the source 405 as an available wireless client device to the user interface. Flow diagram 400 then proceeds to the sink configuration stage 430.

The sink configuration stage 430 begins with the sink 415 sending a connection request to the wireless home media controller 410. The request may include data rates, VBR/CBR, delay, etc. The wireless home media controller 410 creates a device profile for the sink and assigns appropriate quality of service. The wireless home media controller 410 then informs the sink 415 that the connection is okay, and adds the sink 415 as an available wireless client device to the user interface. Flow diagram 400 then proceeds to the network configuration stage 435.

The network configuration stage 435 begins with the user requesting “playback” of given media (or more specifically with the user selecting a source 405 and sink 415 to effect a media presentation). The wireless home media controller 410 creates a static connection profile, and informs the user that the request is okay. Flow diagram 400 then proceeds to the device operation stage 440.

The device operation stage 440 begins with the source 405 transmitting a playback request, which may include the selection of media content, to the wireless home media controller 410. The wireless home media controller 410 allocates bandwidth and operating frequency (RF channel), and returns configuration parameters (e.g., RF channel spectrum parameters) to the source 405 and to the sink 415. Now configured, the source 405 begins sending media content to the sink 415 using the configuration parameters.

FIG. 5 is block diagram illustrating example details of the wireless abstraction layer 140. In one embodiment, the wireless abstraction layer 140 includes sensing module 215, which may be capable of sensing broadband CR MAC and PHY, RF interference, quality estimations, and legacy MAC and PHY.

FIG. 6 is a block diagram illustrating example details of the wireless home media controller 115. Wireless home media controller 115 includes a device detection module (e.g., noticing when devices move in an out of the environment), a quality of service negotiation module (e.g., monitoring the speed of device communications, error rates, device needs, etc.), policy enforcement (e.g., which can be related to arbitration—priority issues, and can be user defined, predefined or dynamically defined), and access point functionality.

FIG. 7 is a block diagram illustrating example details of the policy database 120. Policy database 120 includes network configurations, a frequency pool (e.g., 3-10 GHz), and an arbitration policy. Network configurations identify the available protocols, formats, frequencies, etc. for each source/sink pair. The frequency pool identifies the total available list of frequencies available for each of the source/sink pairs. The arbitration policy enables selection of frequencies for multiple source/sink pairs in use. For example, if one user requests watching a DVD on a particular television and another user requests listening to a CD on a particular set of speakers, the arbitration policy will determine access rights, playback priorities, etc. These priorities can be preset or user defined.

The architecture can be applied using the following technologies:

1. MIMO and Diversity Coding Technologies

MIMO technologies are promising in home media distribution solutions. It has been shown that a home environment can increase the capacity of a given air-resource. Although the architecture 100 is agnostic of the underlying operation frequency bands or coding techniques, the path table can be used to enhance and complement the behavior of current and emerging MIMO technologies. MIMO technologies use diversity coding techniques to increase redundancy and improve reliability. The path table when used with the MIMO technology can create smart MIMO solutions.

2. Other Emerging Technologies

Emerging technologies can be used within the proposed architecture providing enhanced overall performance.
MIMO technologies for PHY/radio connectivity between links in the path table using directional beam-forming antennas. The path table can be used to improve performance of the MIMO PHY section
802.11e schemes like block-ACK and direct link
802.11n or 15.3a for direct high speed communication
802.11k for measurement of network parameters
802.11v management

The architecture may provide reliable media content distribution inside a home environment at a low cost. The architecture 100 is generic and may be applied to any frequency band(s) and may easily incorporate new standards like 802.11e and 802.11k.

FIG. 8 is a block diagram illustrating details of an example computer system 800, of which each wireless client devices and home media controller 115 may be an instance. Computer system 800 includes a processor 805, such as an Intel Pentium® microprocessor or a Motorola Power PC® microprocessor, coupled to a communications channel 855. The computer system 800 further includes an input device 810 such as a keyboard or mouse, an output device 815 such as a cathode ray tube display, a communications device 820, a data storage device 825 such as a magnetic disk, and memory 830 such as Random-Access Memory (RAM), each coupled to the communications channel 855. The communications interface 820 may be coupled to a network such as the wide-area network commonly referred to as the Internet. One skilled in the art will recognize that, although the data storage device 825 and memory 830 are illustrated as different units, the data storage device 825 and memory 830 can be parts of the same unit, distributed units, virtual memory, etc.

The data storage device 825 and/or memory 830 may store an operating system 835 such as the Microsoft Windows NT or Windows/95 Operating System (OS), the IBM OS/2 operating system, the MAC OS, or UNIX operating system and/or other programs 840. It will be appreciated that a preferred embodiment may also be implemented on platforms and operating systems other than those mentioned. An embodiment may be written using JAVA, C, and/or C++ language, or other programming languages, possibly using object-oriented programming methodology.

One skilled in the art will recognize that the computer system 800 may also include additional information, such as network connections, additional memory, additional processors, LANs, input/output lines for transferring information across a hardware channel, the Internet or an intranet, etc. One skilled in the art will also recognize that the programs and data may be received by and stored in the system in alternative ways. For example, a computer-readable storage medium (CRSM) reader 845 such as a magnetic disk drive, hard disk drive, magneto-optical reader, CPU, etc. may be coupled to the communications bus 855 for reading a computer-readable storage medium (CRSM) 850 such as a magnetic disk, a hard disk, a magneto-optical disk, RAM, etc. Accordingly, the computer system 800 may receive programs and/or data via the CRSM reader 845. Further, it will be appreciated that the term “memory” herein is intended to cover all data storage media whether permanent or temporary.

One skilled in the art will recognize that the computer system 800 may also include additional information, such as network connections, additional memory, additional processors, LANs, input/output lines for transferring information across a hardware channel, the Internet or an intranet, etc. One skilled in the art will also recognize that the programs and data may be received by and stored in the system in alternative ways. For example, a computer-readable storage medium (CRSM) reader 845 such as a magnetic disk drive, hard disk drive, magneto-optical reader, CPU, etc. may be coupled to the communications bus 855 for reading a computer-readable storage medium (CRSM) 850 such as a magnetic disk, a hard disk, a magneto-optical disk, RAM, etc. Accordingly, the computer system 800 may receive programs and/or data via the CRSM reader 845. Further, it will be appreciated that the term “memory” herein is intended to cover all data storage media whether permanent or temporary.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A system, comprising:
a wireless source device;
a wireless sink device; and
a wireless controller including
a sensing module for sensing potentially interfering signals in the path of the wireless source device and the wireless sink device;
an admission module for obtaining communication need information for effective communication between the wireless source device and the wireless sink device; and
an allocation module for selecting an RF channel based on the potentially interfering signals sensed and the communication need information for the wireless source device and the wireless sink device to use for its intercommunication.

2. The system of claim 1, wherein the source device includes a DVD player and the sink device includes a television.

3. The system of claim 1, wherein the source device includes a music player and the sink device includes speakers.

4. The system of claim 1, wherein the source device includes a computer and the sink device includes a television.

5. The system of claim 1, wherein the sensing module includes a single sensor for sensing the interfering signals for the entire operating environment.

6. The system of claim 1, wherein the sensing module includes distributed modules for sensing the interfering signals for the entire operating environment.

7. The system of claim 1, wherein the sensing module senses interfering signals periodically.

8. The system of claim 1, wherein the sensing module senses ambient interfering signals.

9. The system of claim 1, wherein the communication needs include Tspec and Rspec for the source device and the sink device.

10. The system of claim 1, wherein the allocation module selects the RF channel further based on available channels.

11. The system of claim 1, wherein the allocation module selects the RF channel further based on noted problems.

12. A method, comprising:
sensing potentially interfering signals in the path of a wireless source device and a wireless sink device;
obtaining communication need information for effective communication between the wireless source device and the wireless sink device; and
selecting an RF channel based on the potentially interfering signals and the communication need information for the wireless source device and the wireless sink device to use for its intercommunication.

13. The method of claim 12, wherein the source device includes a DVD player and the sink device includes a television.

14. The method of claim 12, wherein the source device includes a music player and the sink device includes speakers.

15. The method of claim 12, wherein the source device includes a computer and the sink device includes a television.

16. The method of claim 12, wherein the sensing includes using a single sensor to sense the interfering signals for the entire operating environment.

17. The method of claim 12, wherein the sensing includes using distributed modules to sense the interfering signals for the entire operating environment.

18. The method of claim 12, wherein the sensing senses interfering signals periodically.

19. The method of claim 12, wherein the sensing senses ambient interfering signals.

20. The method of claim 12, wherein the communication needs include Tspec and Rspec for the source device and the sink device.

21. The method of claim 12, wherein the selecting selects the RF channel further based on available channels.

22. The method of claim 12, wherein the selecting selects the RF channel further based on noted problems.

23. A system, comprising:
means for sensing interfering signals in the path of a wireless source device and a wireless sink device;
means for obtaining communication need information for effective communication between the wireless source device and the wireless sink device; and
means for selecting an RF channel based on the interfering signals and the communication need information for the wireless source device and the wireless sink device to use for its intercommunication.
